(19) United States
(12) Patent Application Publication
(10) Pub. No.: US 2009/0299511 A1
(43) Pub. Date: Dec. 3, 2009

(54) METHOD OF RELEASING UNITS IN A PRODUCTION FACILITY

(75) Inventors: John Chan, Hyde Park, NY (US); Jeffrey P. Gifford, Fishkill, NY (US); Roger M. Young, Warwick, NY (US)

Correspondence Address: CANTOR COLBURN LLP - IBM FISHKILL, 20 Church Street, 22nd Floor, Hartford, CT, 06103, US

(73) Assignee: International Business Machines Corporation, Armonk, NY (US)

(21) Appl. No.: 12/129,791

(22) Filed: May 30, 2008

(51) Int. Cl. G06F 19/00

(52) U.S. Cl. 700/102

(57) ABSTRACT

A method of releasing units in a production facility includes forming a release plan for a production facility that establishes a number of units to be operated on by a production process, and creating a least one recipe bucket having an associated number of units. The method further requires evaluating production process throughput parameters, and comparing the number of units associated with the at least one recipe bucket with the number of units to be operated on by the production process and production process throughput parameters. If the number of units in the recipe bucket matches the number of units to be operated on by the production process and production process throughput parameters, recipe bucket is released to the production process, else the at least one recipe bucket is delayed from being released to the production process.

### BACKGROUND OF THE INVENTION

1. Field of the Invention

This invention relates to the art of manufacturing and, more particularly, to a method of releasing lots in a production facility.

2. Description of Background

Modern production facilities utilize many different tools to support a variety of manufacturing processes. Most manufacturing processes are operated in serial or batch modes. In serial mode, units are processed one after another in a process sequence. In batch mode, units are grouped together in a batch and processed contemporaneously. In order for a production line to run efficiently, each batch tool must be fully loaded when processing a batch. In addition, when operating in serial mode, processing like units minimizes tooling changes and setup time during a production period.

Current release strategies rely solely on customer demand and do not account for production line constraints. As a result, batch tools are often not fully loaded, and changes are made during a serial run in order to meet customer production requirements. In addition, units are run without sufficient “training” or test runs, resulting in excessive tool setup which slows production throughput and increases quality review.

### SUMMARY OF THE INVENTION

The shortcomings of the prior art are overcome and additional advantages are provided through the provision of a method of releasing units in a production facility. The method includes forming a release plan for a production facility. The release plan establishes a number of units to be operated on by a production process, and creating a least one recipe bucket having an associated number of units each sharing common operational parameters. The method further requires evaluating production process throughput parameters, and comparing the number of units associated with the at least one recipe bucket with the number of units to be operated on by the production process in the release plan and production process throughput parameters. If the number of units associated with the at least one recipe bucket match the number of units to be operated on by the production process and production process throughput parameters, the at least one recipe bucket is released to the production process. However, if the number of units in the at least one recipe bucket does not match the number of units to be operated on by the production process and production process throughput parameters, the at least one recipe bucket is delayed from being released to the production process.

System and computer program products corresponding to the above-summarized methods are also described and claimed herein.

Additional features and advantages are realized through the techniques of exemplary embodiments of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which creates a release plan that utilizes production processes more efficiently. That is, before releasing units to a production process or tool, a determination is made that the number of units desired to be released substantially aligns with both a production strategy (daily, weekly goals) and tool throughput capabilities so as to ensure an efficient allocation of production resources.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a flow diagram illustrating a method of releasing units in a production facility in accordance with an exemplary embodiment of the invention; and

FIG. 2 is a schematic block diagram of a general-purpose computer suitable for practicing the present invention exemplary embodiments.

The detailed description explains the exemplary embodiments of the invention, together with advantages and features, by way of example with reference to the drawings.

### DETAILED DESCRIPTION OF THE INVENTION

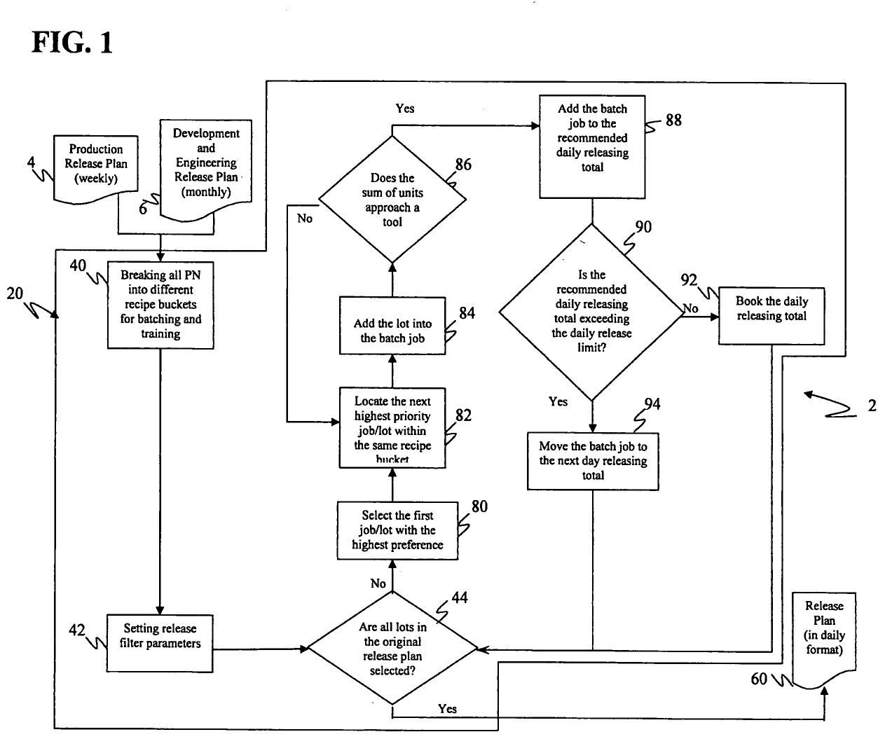

With initial reference to FIG. 1, a method of releasing units in a production facility is indicated generally at 2. Business and Sales Department personnel develop unit requirements on a weekly/monthly basis for both Production units and Development units. More specifically, prior to releasing units to a production process, a production release plan is established for the production facility. The production release plan defines release requirements for the production facility. In some cases, the release plan includes a weekly plan such as indicated in block 4 that sets out weekly goals for each tool in the production facility for a particular customer. In other cases, a release plan includes monthly goals for each tool in the production facility that reflects needs for another customer such as indicated in block 6. Once established, the release plan(s) is passed into a releasing strategy enhancement vehicle (RSEV), illustrated generally at 20. Once the release requirements have been defined by the release plan, the RSEV requests recipe information for candidate release units from a bill of material (BOM) portion of a manufacturing execution system (MES). The BOM includes a breakdown of all part numbers for each recipe. The candidate units are divided into various recipe buckets that are used for batching or training such as indicated in block 40. By batching it should be understood that units are operated on in parallel, i.e., all units in a bucket are exposed to a particular production process simultaneously. Training defines a series operation. That is, units are passed through a process or tool sequentially. In any event, the units in a particular recipe bucket share common operational or production parameters. That is, each unit in a particular recipe bucket requires the same productions steps.

Once the various recipe buckets are established in block 40, RSEV 20 sets release filter parameters for each recipe bucket as indicated in block 42. Release filter or batching parameters represent a set of variables arranged in a sequential order of importance that establish a release schedule based on a set of contingencies. For example, filter parameters can include variables such as throughput parameters including maximum capacity for a batching tool, changeover time for a series or training tool, available throughput for a process or tool or priority parameters such as need for a particular set of units, or an on time delivery percentage for a particular process or tool. After the release filter parameters are set, RSEV 20 evaluates which lots are selected for processing as indicated in block 44. That is, RSEV 20 determines whether each recipe bucket contains an optimal number of candidate units for processing by a production process or tool in order to make efficient use of production facility resources.

In the case of batch processing, RSEV 20 determines whether each recipe bucket contains an optimum number of candidate units to be operated on in a batch. In the case of serial processing, e.g. training, RSEV 20 determines whether each recipe unit contains an optimal number of candidate units to be processed in series before requiring retooling of a particular process or tool. In any case, if, in block 44, the recipe bucket matches the number of units established to be operated on by a particular process in the release plan, the lots are passed to a final, daily release plan and then on to the production facility for processing such as indicated in block 60.

If, however, RSEV 20 determines that the number of units associated with a particular recipe bucket is less than the number of units outlined in the release plan, a determination is made which job or lot associated with a particular recipe bucket has the highest preference as indicated in block 80. Next, RSEV 20 locates the next highest priority job or lot associated with the same recipe bucket as indicated in block 82. The job lot with the highest preference is then combined with the job lot having the next highest preference to form a combined job lot or bucket as indicated in block 84. After forming the combined job lot, RSEV 20 determines whether some of the units within the combined job lot approach a tool processing limitation as indicated in block 86. If not, RSEV 82 locates the next highest priority job lot which is in the same recipe bucket to add to the combined bucket until the sum of units in the combined bucket approaches the tool processing limitation. At this point, the combined job lot is added to a batch job that is recommended for a daily releasing total as indicated in block 88.

At this point, RSEV 20 determines whether the daily releasing total exceeds a total daily release limit for a particular day. That is, RSEV 20 determines whether the combined job lot can be added to other lots on a particular process or tool so as to be processed within a given production day as indicated in block 90. If the combined batch job, when added to the daily releasing total, does not exceed the daily release limit, the combined job lot is passed on or added to the daily release schedule as indicated in block 92 and passed back to block 94 to determine whether all lots in the original release plan are selected. If the combined batch job exceeds the daily release when added to the daily release schedule, the combined job lot is moved to a next day releasing total as indicated in block 94 and passed back to block 44 to determine whether all lots in the combined job lot meet the number of units to be operated on by a process tool in the release plan. In this manner, RSEV 20 ensures that each production process or tool is utilized in an efficient manner such that for example batching jobs are not carried out with partial batches or, serial process lines are not interrupted and retooled after processing a few units only to be re-tooled again to process additional units having similar requirements. Thus, RSEV 20 enhances an overall production output, while ensuring on time delivery and high quality.

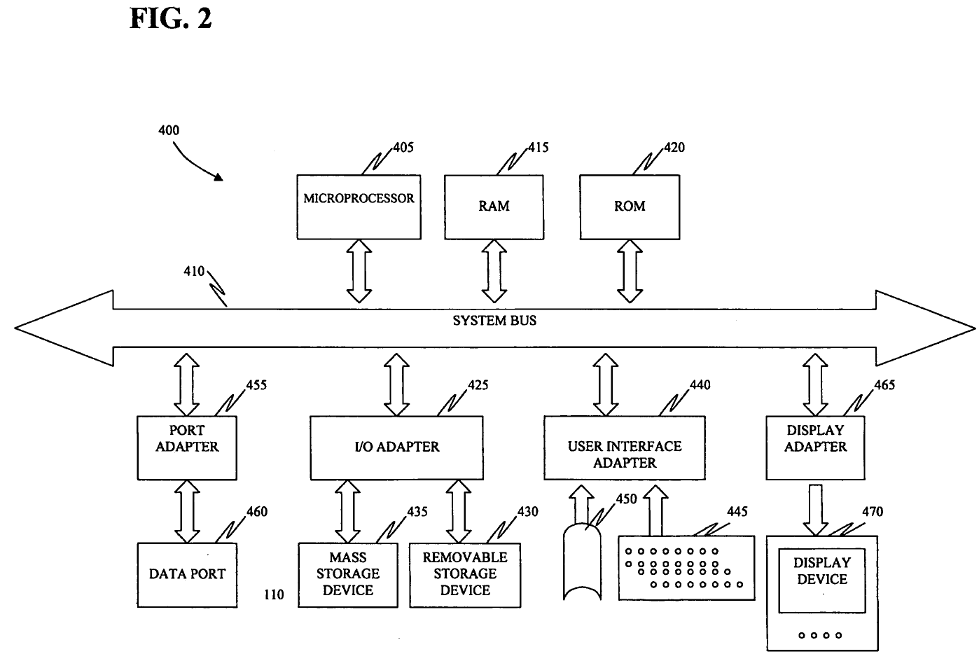

Generally, the method of releasing units in a production facility described herein is practiced with a general-purpose computer and the method may be coded as a set of instructions on removable or hard media for use by the general-purpose computer. FIG. 2 is a schematic block diagram of a general-purpose computer suitable for practicing the present invention embodiments. In FIG. 2, computer system 400 has at least one microprocessor or central processing unit (CPU) 405. CPU 405 is interconnected via a system bus 410 to a random access memory (RAM) 415, a read-only memory (ROM) 420, an input/output (I/O) adapter 425 for a connecting a removable data and/or program storage device 430 and a mass data and/or program storage device 435, a user interface adapter 440 for connecting a keyboard 445 and a mouse 450, a port adapter 455 for connecting a data port 460 and a display adapter 465 for connecting a display device 470.

ROM 420 contains the basic operating system for computer system 400. The operating system may alternatively reside in RAM 415 or elsewhere as is known in the art. Examples of removable data and/or program storage device 430 include magnetic media such as floppy drives and tape drives and optical media such as CD ROM drives. Examples of mass data and/or program storage device 435 include hard disk drives and non-volatile memory such as flash memory. In addition to keyboard 445 and mouse 450, other user input devices such as trackballs, writing tablets, pressure pads, microphones, light pens and position-sensing screen displays may be connected to user interface 440. Examples of display devices include cathode-ray tubes (CRT) and liquid crystal displays (LCD).

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

1. A method of releasing units in a production facility, the method comprising:
forming a release plan for a production facility, the release plan establishing a number of units to be operated on by a production process;
creating a least one recipe bucket having an associated number of units, each of the number of units sharing common operational parameters;
evaluating production process throughput parameters; and
comparing the number of units associated with the at least one recipe bucket with the number of units to be operated on by the production process in the release plan and production process throughput parameters, wherein if the number of units associated with the at least one recipe bucket match the number of units to be operated on by the production process and production process throughput parameters, the at least one recipe bucket is released to the production process and, wherein if the number of units in the at least one recipe bucket does not match the number of units to be operated on by the production process and production process throughput parameters, the at least one recipe bucket is delayed from being released to the production process.

2. The method of claim 1, further comprising:
adding units from another recipe bucket to the at least one recipe bucket to establish a combined recipe bucket if the number of units in the at least one recipe bucket does not match the number of units to be operated on by the production process and production process throughput parameters;
comparing the number of the of units in the combined recipe bucket with the number of units to be operated on by the production process established in the release plan and the production process throughput parameters; and
releasing the combined recipe bucket to the production process if the number of units in the combined recipe bucket matches the number of units to be operated on by the production process and the production process throughput parameters.

3. The method of claim 2, further comprising:
determining if a daily release inventory matches a daily release limit; and
adding the combined recipe bucket to the daily release inventory if the daily release inventory is below the daily release limit.

4. The method of claim 3, further comprising: delaying release of the combined recipe bucket to the daily release inventory if the daily release inventory is at the daily release limit.

5. The method of claim 1, further comprising: establishing at least one release filter parameter for the at least one recipe bucket.

6. The method of claim 5, wherein establishing the at least one release filter parameter comprises establishing a priority parameter.

7. The method of claim 6, wherein establishing a priority parameter includes setting at least one of a processing priority parameter and an on time delivery percentage parameter.

8. The method of claim 1, wherein associating the number of the plurality of units with at least one recipe bucket comprises creating at least one of a batching recipe bucket and one of a training recipe bucket.

9. A system for establishing a release plan for a production facility, the system comprising:
a central processing unit (CPU), said CPU being interconnected functionally via a system bus to:
an input/output (I/O) adapter connecting to at least one of a removable data storage device, a program storage device, and a mass data storage device;
a user interface adapter connecting to one or more computer input devices;
a display adapter connecting to a display device; and
at least one memory device thereupon stored a set of instructions which, when executed by said CPU, causes said system to:
form a release plan for a production facility, the release plan establishing a number of units to be operated on by a production process;
create a least one recipe bucket having an associated number of units, each of the number of units sharing common operational parameters;
evaluate production process throughput parameters; and
compare the number of units associated with the at least one recipe bucket with the number of units to be operated on by the production process in the release plan and production process throughput parameters, wherein if the number of units associated with the at least one recipe bucket match the number of units to be operated on by the production process and production process throughput parameters, the at least one recipe bucket is released to the production process and, wherein if the number of units in the at least one recipe bucket does not match the number of units to be operated on by the production process and production process throughput parameters, the at least one recipe bucket is delayed from being released to the production process.

10. The system according to claim 9, wherein the set of instructions which, when executed by said CPU, causes said system to:
add units from another recipe bucket to the at least one recipe bucket to establish a combined recipe bucket if the number of units in the at least one recipe bucket does not match the number of units to be operated on by the production process and production process throughput parameters;
compare the number of the of units in the combined recipe bucket with the number of units to be operated on by the production process established in the release plan and the production process throughput parameters; and
release the combined recipe bucket to the production process if the number of units in the combined recipe bucket matches the number of units to be operated on by the production process and the production process throughput parameters.

11. The system according to claim 10, wherein the set of instructions which, when executed by said CPU, causes said system to:
determine if a daily release inventory matches a daily release limit; and
add the combined recipe bucket to the daily release inventory if the daily release inventory is below the daily release limit.

12. The system according to claim 11, wherein the set of instructions which, when executed by said CPU, causes said system to: delay release of the combined recipe bucket to the daily release inventory if the daily release inventory is at the daily release limit.

14. The system according to claim 9, wherein the set of instructions which, when executed by said CPU, causes said system to: establish at least one release filter parameter for the at least one recipe bucket.

15. The system according to claim 9, wherein the set of instructions which, when executed by said CPU, causes said system to: create at least one of a batching recipe bucket and one of a training recipe bucket.

16. A computer program product comprising:
a computer useable medium including a computer readable program, wherein the computer readable program when executed on a computer causes the computer to:
form a release plan for a production facility, the release plan establishing a number of units to be operated on by a production process;
create a least one recipe bucket having an associated number of units, each of the number of units sharing common operational parameters;
evaluate production process throughput parameters; and
compare the number of units associated with the at least one recipe bucket with the number of units to be operated on by the production process in the release plan and production process throughput parameters, wherein if the number of units associated with the at least one recipe bucket match the number of units to be operated on by the production process and production process throughput parameters, the at least one recipe bucket is released to the production process and, wherein if the number of units in the at least one recipe bucket does not match the number of units to be operated on by the production process and production process throughput parameters, the at least one recipe bucket is delayed from being released to the production process.

17. The computer program product according to claim 16, wherein the computer readable program when executed on a computer causes the computer to:
add units from another recipe bucket to the at least one recipe bucket to establish a combined recipe bucket if the number of units in the at least one recipe bucket does not match the number of units to be operated on by the production process and production process throughput parameters;
compare the number of the of units in the combined recipe bucket with the number of units to be operated on by the production process established in the release plan and the production process throughput parameters; and
release the combined recipe bucket to the production process if the number of units in the combined recipe bucket match at least one of the number of units to be operated on by the production process and the production process throughput parameters.

18. The computer program product according to claim 17, wherein the computer readable program when executed on a computer causes the computer to:
determine if a daily release inventory matches a daily release limit; and
add the combined recipe bucket to the daily release inventory if the daily release inventory is below the daily release limit.

19. The computer program product according to claim 18, wherein the computer readable program when executed on a computer causes the computer to: delay release of the combined recipe bucket to the daily release inventory if the daily release inventory is at the daily release limit.

20. The computer program product according to claim 16, wherein the computer readable program when executed on a computer causes the computer to: establish at least one release filter parameter for the at least one recipe bucket.
